(19) United States
(12) Patent Application Publication
(10) Pub. No.: US 2017/0149555 A1
(43) Pub. Date: May 25, 2017

(54) SELF-TEST FOR SOURCE-SYNCHRONOUS INTERFACE

(71) Applicant: QUALCOMM Incorporated, San Diego, CA (US)

(72) Inventors: Hanan Cohen, San Diego, CA (US); Jason Thurston, Raleigh, NC (US)

(21) Appl. No.: 14/947,278

(22) Filed: Nov. 20, 2015

(51) Int. Cl. H04L 7/033; H04L 7/00

(52) U.S. Cl. CPC H04L 7/0332; H04L 7/0012; H04L 7/0334

(57) ABSTRACT

A source-synchronous system is provided in which a master device is configured to vary the phase between a transmitted data signal and a corresponding source-synchronous clock to measure the margins of a data eye at a slave device.

### TECHNICAL FIELD

This application relates to source-synchronous communication, and more particularly to the techniques of a self-test for a source-synchronous interface between a transmitting integrated circuit and a receiving integrated circuit.

### BACKGROUND

In a source-synchronous system, a transmitter transmits a clock with the data to a receiver. The clock must be aligned properly with the data so that the receiver may sample the data properly. In particular, the receiver uses one or both clock edges (rising and falling) in the clock to sample the data. Each data bit (or symbol in higher-order modulation schemes) has a period over which it is transmitted. The corresponding clock edge should be aligned in the middle of this period so that the data bit or symbol may be sampled. This alignment is typically denoted as being within the “data eye.” But if the clock is too early or too late compared to the data, transmission errors occur. It is thus important to verify the clock alignment at the receiver in a source-synchronous system.

To verify the clock timing in a source-synchronous system, it is conventional to insert a lab instrument into the clock and data path coupling from the transmitter to the receiver. But such an insertion of test equipment disrupts the system so as to alter the test results and may even result in complete failure of the communication link. There is thus a need in the art for improved testing of source-synchronous systems.

### SUMMARY

A source-synchronous system is provided in which a master device transmits a data signal having a known pattern to a slave device and also transmits a corresponding source-synchronous clock signal to the slave device. The slave device is configured to retransmit the data signal back to the master device responsive to the received source-synchronous clock signal. By varying a phase alignment between the transmitted data and the transmitted source-synchronous clock signal until an error is detected in the retransmitted data received at the master device, the master device characterizes the margins for a data eye at the slave device. This is quite advantageous as the resulting margin characterization requires no insertion of any external test equipment into the source-synchronous system. The master device is further configured to vary a sampling of the retransmitted data to characterize the margins for a data eye at the master device.

### BRIEF DESCRIPTION OF THE DRAWINGS

FIG. 1A is a diagram of one example of a source-synchronous system in which a master device is configured to vary the phase alignment of a data stream relative to a source-synchronous clock to characterize the margins of a data eye at a slave device in accordance with an aspect of the disclosure.

FIG. 1B is a diagram of one example of a source-synchronous system in which a master device is configured to vary the phase alignment of a source-synchronous clock signal relative to a corresponding data stream to characterize the margins of a data eye at a slave device in accordance with an aspect of the disclosure.

FIG. 2A is a detailed flowchart of one example of a method of characterizing the margins for the data eye at the slave device by the master device of FIG. 1A.

FIG. 2B is a detailed flowchart of one example of a method of characterizing the margins for the data eye at the master device in either system of FIGS. 1A and 1B.

FIG. 3 is a summary flowchart for the method of characterizing the margins of the data eye at the slave device in either system of FIGS. 1A and 1B.

FIG. 4 is a summary flowchart for the method of characterizing the margins of the data eye at the master device in either system of FIGS. 1A and 1B.

Embodiments of the disclosure and their advantages are best understood by referring to the detailed description that follows. It should be appreciated that like reference numerals are used to identify like elements illustrated in one or more of the figures.

### DETAILED DESCRIPTION

To provide a self-test capability for a source-synchronous interface, a master integrated circuit is configured to transmit a known pattern of data to a slave integrated circuit and to transmit a source-synchronous clock signal to the receiving integrated circuit. The known pattern of data propagates over a data channel from the master integrated circuit to the receiving integrated circuit. Similarly, the source-synchronous clock signal propagates over a clock channel from the master integrated circuit to the receiving integrated circuit. As known in the source-synchronous arts, the slave integrated circuit includes a phase alignment circuit that adjusts the phase of the received source-synchronous clock to be in the middle of the data eye so that the receiving integrated circuit may properly sample the received known pattern responsive to the aligned clock. Such alignment also accounts for the skew between the clock and data channels. The phase alignment circuit in the receiving integrated circuit accounts for this skew and re-aligns the received source-synchronous clock so as to be centered in the slave device data eye.

The master integrated circuit controls the slave integrated circuit to lock the phase alignment of the received source-synchronous clock once the receiving integrated circuit has properly aligned the received clock so as to be within the slave device data eye. For brevity, the master integrated circuit will also be denoted herein as the master device. Similarly, the slave integrated circuit will also be denoted herein as the slave device. With the slave phase alignment circuit locked, the master device may proceed to perform two measurements. In a first measurement, the master device characterizes the margins of the data eye at the slave device by varying the phasing of the transmitted data with regard to the transmitted source-synchronous clock. The slave device is configured to retransmit the received data back to the master device while its phase alignment circuit is locked. In a second measurement, the master device characterizes the margins of the data eye at the master device for the retransmitted data.

Prior to the testing of the data eye at the slave, the master device transmitted the data synchronously with regard to the source-synchronous clock to the slave device. At the master device, the transmitted data thus has an initial phase alignment with regard to the transmitted source-synchronous clock. The source-synchronous clock is chosen from several source clocks sourced from a multi-phase clock source, such as a four-phase phase-locked loop (PLL). For example, the four-phase PLL may produce a 0 degree source clock, a 90 degree source clock, a 180 degree source clock, and a 270 degree source clock. The selected source-synchronous clock may be a differential pair from these four source clocks. For example, the 0 degree clock and the 180 degree clock may be selected to form the source-synchronous clock transmitted to the slave device. To test the positive margin for the data eye at the slave device, the master device may progressively advance the phasing of the transmitted data with regard to its initial phase alignment with transmitted source-synchronous clock until the master device detects that the retransmitted data it receives from the slave device is erroneous as compared to the known pattern originally transmitted from the master device. Alternatively, the master device may progressively delay the phasing of the transmitted source-synchronous clock from its initial phase alignment with the transmitted data until the master device detects errors in the retransmitted data to characterize the positive margin for the data eye at the slave device.

To test the negative margin for the data eye at the slave device, the master device may progressively delay the phasing of the transmitted data from its initial phase alignment with the transmitted source-synchronous clock until the master device detects that the retransmitted data received from the slave device is erroneous. Conversely, the master device may progressively advance the phasing of the transmitted source-synchronous clock from its initial phase alignment with the transmitted data until the master device detects that the retransmitted data received from the slave device is erroneous to characterize the negative margin for the data eye at the slave device. Having determined the positive and negative margins for the data eye at the slave device, the master may then proceed to determine which margin is smallest in order to determine the minimum data eye margin at the slave device.

With regard to characterizing the data eye margins at the master device for the retransmitted data received from the slave device, note that the master device has its own phase alignment circuit to interpolate from the source clocks to produce a sampling clock that is centered in the data eye for the retransmitted data (the looped-back data) from the slave device. The sampling clock is thus a phase-adjusted version of the source-synchronous clock transmitted to the slave device. For example, a receiver in the master for receiving the retransmitted data may include a phase interpolator configured to interpolate between the various source clocks from the multi-phase clock source to produce a sampling clock. To characterize the data eye margins at the master device for the retransmitted data, the master device forces its receiver phase interpolator to vary the phase of the sampling clock. While this phase is varied, the master samples the retransmitted data responsive to sampling clock to determine a received pattern for the sampled retransmitted data. By comparing the received pattern to the known transmitted pattern, the master device may determine when the phase variation has introduced an error into the sampled retransmitted data to measure the positive and negative margins for the data eye at the master device. For example, the master device may first increase the phase of the sampling clock until an error is detected in the sampled retransmitted data to measure the positive margin of the data eye at the master device. Similarly, the master device may decrease the phase of the sampling clock until an error is detected in the sampled retransmitted data to measure the negative margin of the data eye at the master device. By determining the minimum of the positive and negative margins, the master device determines the minimum data eye margin at the master device.

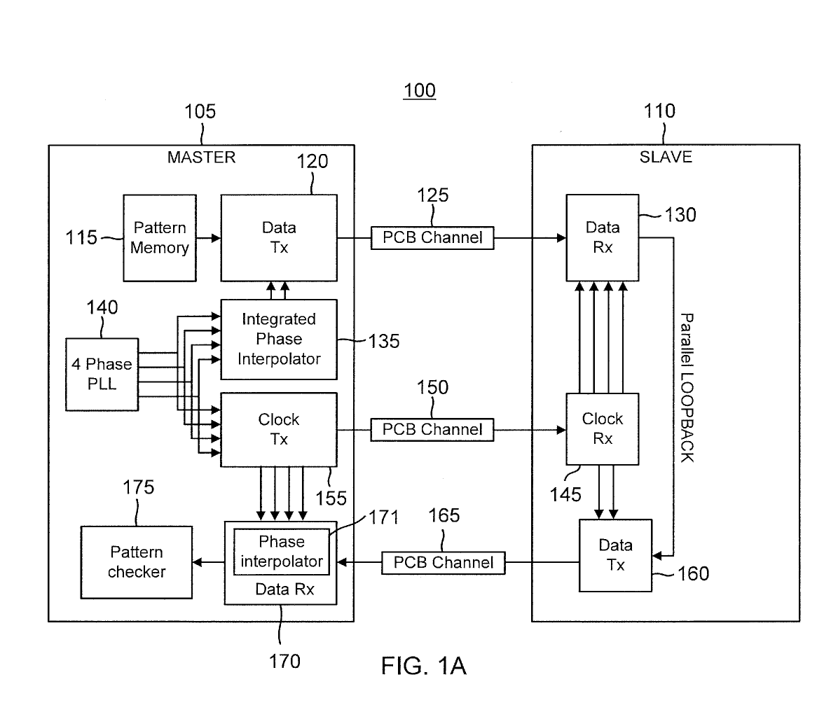

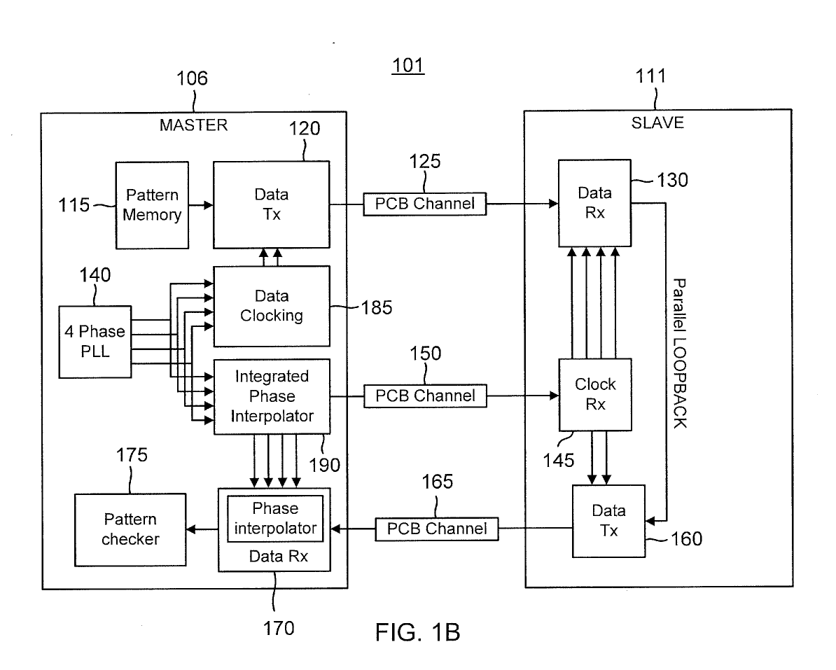

With regard to characterizing the data eye at the slave device, note that either the phase of the transmitted data signal may be varied with respect to the transmitted source-synchronous clock or phase of the transmitted source-synchronous clock may be varied with respect to the transmitted data until the retransmitted data received from the slave device is erroneous. An example embodiment for a system in which the master varies the transmitted data phasing will now be discussed followed by a discussion of a system in which the master device varies the source-synchronous clock signal phasing. Turning now to the drawings, a source-synchronous system 100 is illustrated in FIG. 1A that includes a master device 105 configured to adjust the transmitted data phasing to measure the data eye margins at a slave device 110. Master device 105 includes a multi-phase clock source providing various clock phases such as a four-phase PLL 140 that provides a first differential clock signal formed from a 0 degree clock and a 180 degree clock and also a second differential clock signal formed from a 90 degree clock and a 270 degree clock. Four-phase PLL 140 provides these source clocks to both a clock transmitter 155 and an integrated phase interpolator 135.

Clock transmitter 155 selects a source-synchronous clock from the source clocks provided by four-phase PLL 140 for transmission over a transmission line such as a printed circuit board (PCB) channel 165 to slave device 110. For example, clock transmitter 155 may select the differential clock formed from the 0 degree and 180 degree source clocks to form the transmitted source-synchronous clock. The transmitted source-synchronous clock may also be denoted as the selected clock since it is selected from the source clocks. The following discussion will assume that the selected clock is a differential clock but it will be appreciated that the selected clock may be a single-ended clock in alternative embodiments. To select a differential clock, clock transmitter 155 either selects the 0 degree and 180 degree source clock pair or selects the 90 degree and 270 degree source clock pair in the current example.

Prior to measuring the data eye at the receiver, phase interpolator 135 does not interpolate between the source clocks but instead triggers a master data transmitter 120 to transmit successive bits of a known pattern stored in a memory 115 (which also may be designated as a pattern memory) responsive to the selected clock over a suitable channel such as a PCB data channel 125 to slave device 110. In one embodiment, the known pattern may comprise a pseudo-random bit stream. The bit boundaries for the transmitted data over PCB data channel 125 are thus initially aligned with the clock edges of the selected clock transmitted over PCB clock channel 150. Slave device 110 includes a slave clock receiver (Rx) 145 having a delay circuit (not illustrated) such as a delay-locked loop to generate a delayed version of the received clock. For example, if the received source-synchronous clock is a differential clock including the 0 degree clock and the 180 degree clock, clock receiver may generate a delayed differential clock including a 90 degree clock and a 270 degree clock. Slave clock receiver 145 provides the received differential clock and the delayed differential clock to a slave data receiver (Rx) 130 that includes an phase interpolator (not illustrated) for interpolating from these clocks to produce sampling clock for sampling the received data over PCB data channel 125. As known in the source-synchronous arts, slave data receiver 130 is configured to control its phase interpolation so that the sampling clock is centered in the data eye for the received data.

This centering of the sampling clock within the data eye at slave device 110 may be assumed to take an initialization period of time to finish. After this initialization period is completed, master device 105 may thus assume that the slave device 110 is locked to the received data through the appropriate centering of the sampled clock within the data eye at slave device 110. Although slave device 110 is then correctly sampling the received data, this sampling may not be properly centered or may not have adequate margins. To perform a test of the data eye margins at slave device 110, master device 105 first commands slave data receiver 130 to lock or freeze the interpolation of the clocks from slave clock receiver 145. For example, master device 105 may transmit a sideband signal from master data transmitter 120 over PCB data channel 125 to command slave data receiver 130 to lock its phase interpolation.

Master device 105 may then control phase interpolator 135 to vary the phase of its interpolated clock so as to force the phase of the transmitted data from master data transmitter 120 to progressively vary with regard to the phase for the selected clock transmitted by master clock transmitter 155. Since the phase interpolation within slave device 110 has been locked, this progressive phase offset between the transmitted data and the transmitted selected clock causes the sampling of the received data in slave data receiver 130 to progressively vary from its presumed centering in the slave device data eye. For example, phase interpolator 135 may first progressively advance the phase of the interpolated clock that triggers each bit in the known pattern transmitted by master data transmitter 120 over PCB data channel 125. The sampling in slave data receiver 130 will then progressively drift from its presumed centering in the slave device data eye to its positive margin.

As the sampling in slave data receiver 130 drifts to the positive margin of the data eye, the sampled data from slave data receiver 130 will eventually be in error with regard to the known pattern transmitted by master device 105. To detect this error, slave device 110 is configured to loop the sampled data back to master device 105 through a slave data transmitter (Tx) 160 responsive to the received source-synchronous clock from slave clock receiver 145. Slave data transmitter 160 retransmits the sampled data over a suitable transmission line such as a PCB data channel 165 to a master data receiver (Data Rx) 170 in master device 105. Master data receiver 170 samples this retransmitted data from slave device 110 according to a sampling clock from a phase interpolator 171. Analogous to the interpolation discussed with regard to slave data receiver 130, phase interpolator 171 interpolates from the four source clocks from four-phase PLL 140 so that the resulting sampling of the received retransmitted data is centered within the master device data eye. Given this sampling of the received retransmitted data in master device 105, the corresponding received pattern may be compared to the known pattern in a pattern checker 175. When the received pattern varies from the known pattern, pattern checker 175 has detected an error condition. In that regard, each source-synchronous system such as system 100 will have its own bit error rate (BER) requirement. For example, the BER requirement for system 100 may be no errors in 10¹² transmitted bits. Should the source-synchronous clock rate be 6 GHz, a pattern length of 10¹² bits would require 166 seconds to test. Such a test length may be unsatisfactory such that the pattern length may be made shorter such as 10⁹ bits, which requires just 166 ms to test at a clocking rate of 6 GHz. Should an error be detected over such a shortened pattern length, the original BER requirement for system 100 is of course violated. It will be appreciated that the pattern length selection for alternative embodiments is a function of the desired testing latency versus the BER requirement such that a suitable compromise may be reached with regard to declaring an error condition within a reasonable length of time.

Regardless of the actual pattern length chosen for a specific embodiment, a detection of a difference between the received pattern and the known pattern in pattern checker 175 indicates that a margin of the slave device data eye has been reached. To test the negative margin of the slave device data eye, integrated phase interpolator 135 progressively decreases the phase of the interpolated clock triggering master data transmitter 120 to transmit the known pattern of data bits over PCB data channel 125 to slave device 110. In this fashion, both the positive and negative margins of the slave data eye may be measured at master device 105. This is quite advantageous as no breaking of PCB data channel 125 is required so as to permit the insertion of a test device. Such an insertion is problematic as discussed previously. Yet no such insertion is required in system 100 because master device 105 determines the positive and negative margins of the slave data eye as discussed herein.

An example system 101 in which a master device 106 varies the phasing of the selected source synchronous clock instead of the phasing of the transmitted data is shown in FIG. 1B. As analogously discussed with regard to system 100, master device 106 in system 101 includes a master data transmitter 120 that transmits a known pattern of data as retrieved from pattern memory 115 responsive to a clock. However, master device 106 triggers the data transmission from master data transmitter 120 responsive to the selected source-synchronous clock rather than being responsive to an interpolated clock as was performed in system 100. A data clocking circuit 185 selects from the source clocks from four-phase PLL 140 to present the appropriate differential clock pair to master data transmitter 120. Master data transmitter 120 then proceeds to transmit the known pattern as a data stream over PCB data channel 125 to a slave data receiver 130 in slave device 111 responsive to the transitions of the selected source-synchronous clock from data clocking circuit 185.

At the initiation of a slave data eye margin measurement for slave device 111, an integrated phase interpolator 190 in master device 106 selects for the same differential pair of source clocks as selected by clocking circuit 185 to form a differential clock transmitted over PCB clock channel 150 to slave clock receiver 145 in slave device 111. As discussed with regard to system 100, slave clock receiver 145 includes a delay circuit (not illustrated) such as a delay locked loop (DLL) to produce a delayed differential clock from the received differential clock. Slave clock receiver 145 presents the received differential clock and the delayed differential clock to slave data receiver 130, which interpolates to center an interpolated clock within the slave device data eye.

After slave device 111 has locked onto the received data through an appropriate interpolation within slave data receiver 130, master device 106 commands slave device 111 to freeze or cease further interpolation. Master device 106 may then progressively vary the interpolation within integrated phase interpolator 190 to vary the phasing of the differential clock transmitted over PCB clock channel 150 as compared to the streaming of the known data pattern transmitted over PCB data channel 125 analogously as discussed with regard to master device 105 to measure the margins of the data eye at slave device 111. Integrated phase interpolator 190 progressively increases the phase of the transmitted differential clock until an error is detected by pattern checker 175 in the received pattern from master data receiver 170 to measure the negative margin of the slave device data eye. Similarly, integrated phase interpolator 190 progressively decreases the phase of the transmitted differential clock until an error is detected by pattern checker 175 to measure the positive margin of the slave device data eye.

In one embodiment, phase interpolator 135 in system 100 and phase interpolator 190 may each be deemed to form a means for varying a phase alignment between the transmitted data signal and the transmitted source-synchronous clock signal.

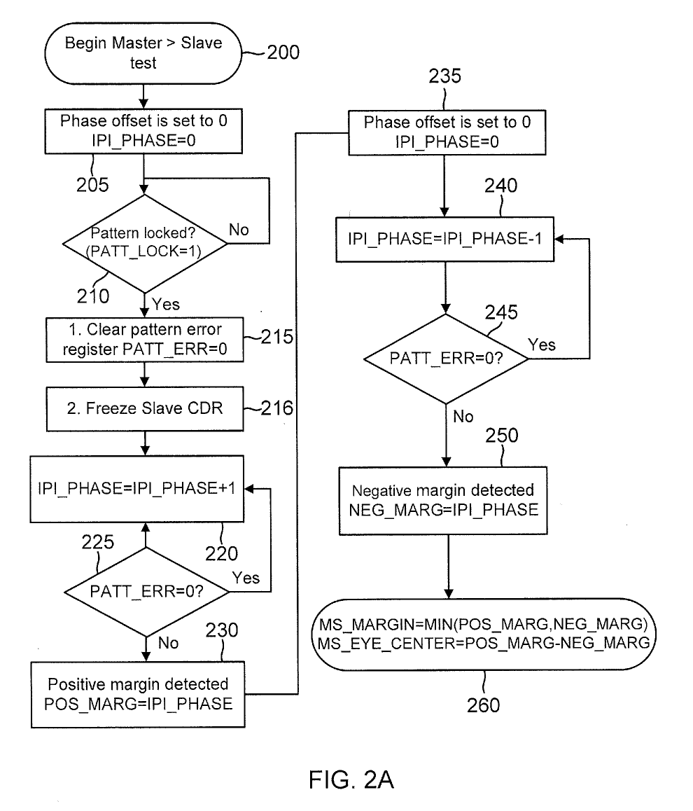

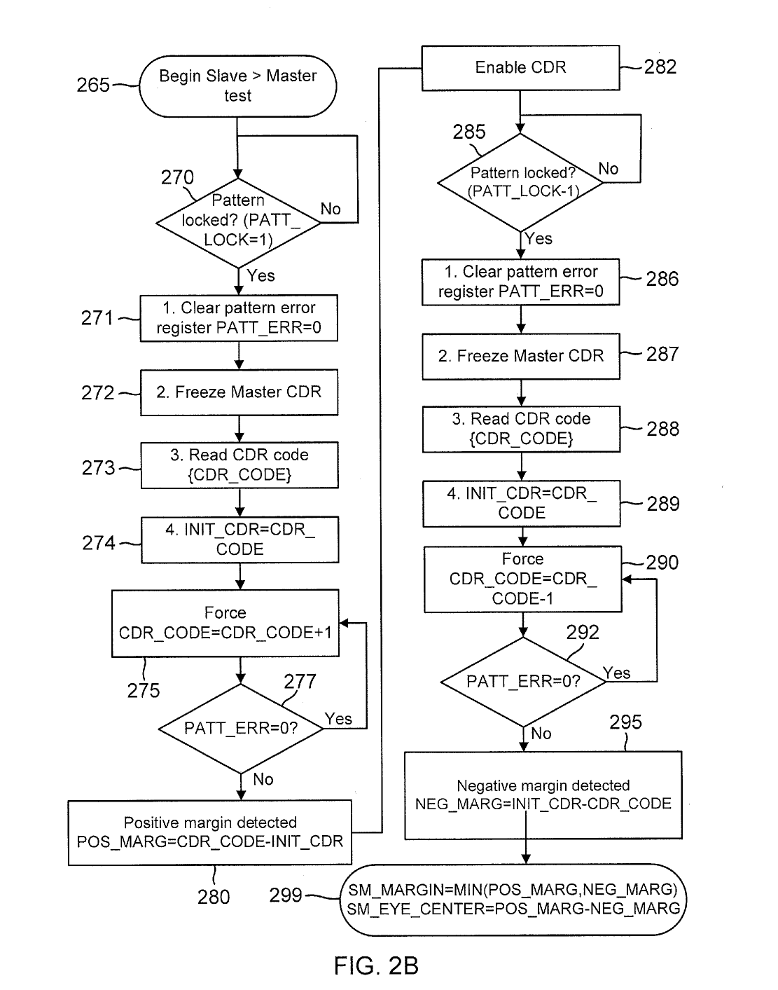

An example method of measuring the slave device data eye margins will now be discussed for system 100 followed by a discussion of an example method of measuring the master device data eye margin for either of systems 100 and 101. The slave device data eye margin measurement begins in step 200 of FIG. 2A. In an act 205, an interpolator phase (IPI_PHASE) for the interpolated clock produced by master device phase interpolator 135 is initialized at zero. The data transmission into PCB data channel 125 and the source-synchronous clock transmission into PCB clock channel 150 thus have a phase offset of 0 degrees with respect to each other in act 205. The method further includes an act 210 of waiting until slave device 110 has locked onto the transmitted data pattern by appropriate interpolation within slave data receiver 130 as discussed earlier. For example, master device 105 may presume that the locking is complete after a minimum period of time has elapsed. This minimum period of time depends upon the interpolation speed within slave data receiver 130. Although these systems are source-synchronous, the phase interpolation within slave data receiver 130 (as well as in master data receiver 170) may be deemed to be a clock data recovery (CDR) operation in that the received source-synchronous clock is appropriately delayed so that the received data may be sampled within the data eye. The interpolation within slave data receiver 130 may thus be deemed as recovering the clock in a clock data recovery operation.

Once slave device 110 has locked onto the transmitted data pattern, an error status (PAT_ERRR) of pattern checker 175 in master device 105 is cleared by setting it to zero in an act 215. The CDR operation (Slave CDR) within slave data receiver 130 is also frozen or ceased in an act 216. The progressive variation of the phase between the transmitted data and the transmitted source-synchronous clock may then begin so that the positive and negative margins of the slave data eye may be characterized. It is arbitrary which margin is characterized first. In FIG. 2A, it is the positive margin that will be characterized first but it will be appreciated that the negative margin may first be characterized in alternative embodiments.

An act 220 begins the positive margin characterization by increasing the phase of the transmitted data by incrementing the interpolator phase IPI_PHASE in integrated phase interpolator 135 by a unit amount. This unit amount may represent the smallest increment possible for the interpolated clock output from phase interpolator 135 as determined by its resolution. The resulting received pattern for the retransmitted data from slave device 110 is compared against the known pattern in pattern checker 175 in an act 225 to determine if the pattern error (PATT_ERR) is still zero. Should the pattern error be zero, the interpolator phase IPI_PHASE is incremented again in act 220 so that the resulting pattern error may again be checked in act 225. Acts 220 and 225 are repeated until a pattern error will be detected in act 225 so that the phase of the positive margin (POS_MARG) of the slave data eye may be characterized by the current incremented value of the interpolator phase. In a differential clock embodiment, the ideal value for the positive margin phase would be 90 degrees as such a value would center the clock within the 180 degrees of phase for the slave data eye. Conversely, the ideal value for the positive margin phase would be 180 degrees in a single-ended embodiment as such a value would center the clock within the 360 degrees of phase for the slave data eye.

With the positive margin characterized, the method may proceed with the negative margin characterization in an act 235 by again initializing the interpolator phase to be zero. The interpolator phase may then be decremented by its minimum unit in an act 240 so that the resulting pattern error may be checked in an act 245. Should there be no pattern errors, acts 240 and 245 are repeated until a pattern error is detected. The negative margin phase (NEG_MARG) is characterized by the current decremented value of the interpolator phase in an act 250. The minimum value of the positive and negative margin phases characterizes the slave device data eye margin minimum (MS_MARGIN) in an act 260. In addition, the difference between the positive and negative margin phases characterizes the slave device data eye center phase (MS_EYE_CENTER) in act 260.

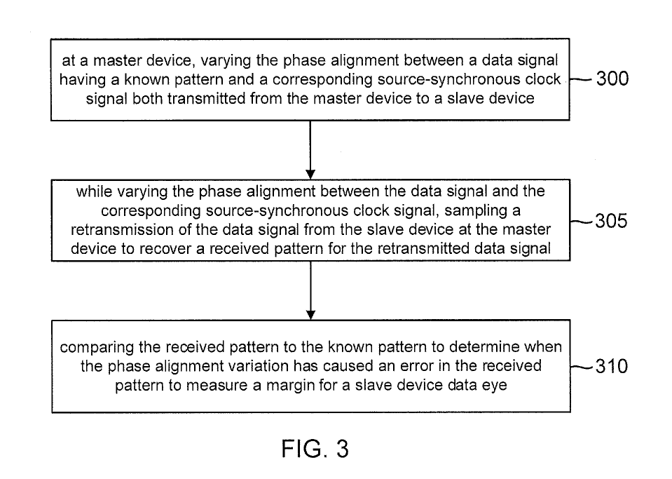

The slave data eye margin characterization method for both systems 100 and 101 may be summarized with regard to FIG. 3. This method is thus generic as whether the phase of the transmitted data is varied or the phase of the transmitted source-synchronous clock is varied. The method begins with an act 300 performed in a master device and includes varying the phase alignment between a data signal having a known pattern and a corresponding source-synchronous clock signal both transmitted from the master device to a slave device. The progressive variation of the phase alignment by integrated phase interpolators 135 and 190 during the transmission of the data signal and the source-synchronous clock signal is an example of act 300.

The slave data eye margin characterization method continues with an act 305 performed while varying the phase alignment between the data signal and the corresponding source-synchronous clock signal and includes sampling a retransmission of the data signal from the slave device at the master device to recover a received pattern for the retransmitted data signal. The sampling of the retransmitted data signal in master data receivers 170 is an example of act 305.

Finally, the slave data eye margin characterization method continues with an act 310 of comparing the received pattern to the known pattern to determine when the phase alignment variation has caused an error in the received pattern to measure a margin for a slave device data eye. The comparison in pattern checker 175 is an example of act 310.

An example method of measuring the master device data eye margin for either of systems 100 and 101 will now be discussed in that the master data eye margin characterization method is common to either system. Referring now to FIG. 2B, the margins for the master data eye are characterized beginning in step 265. As discussed with regard to slave data receiver 130, the phase interpolation from the source clocks from four-phase PLL in phase interpolator 171 in master data receiver 170 is analogous to a clock data recovery (CDR) operation in that the interpolation may be deemed to recover the clock phasing necessary for sampling within the master device data eye. Phase interpolator 171 may thus be deemed to perform a master CDR method with regard to centering the sampling clock within the master data eye. The method continues with an act 267 in which the phase offset (IPM_PHASE) for the sampling clock from phase interpolator 171 is set to zero.

Data is then streamed from master data transmitter 120 through the corresponding device and received at master receiver 170 until master receiver 170 is locked to the received data pattern in an act 270. Once master receiver 170 is locked to the received data pattern, the error status (PATT_ERR) such as stored in an error register in pattern checker 175 is cleared in an act 272. In addition, the master CDR performed by phase interpolator 171 is frozen or ceased in act 272. Although the master CDR is frozen, phase interpolator 171 will have imparted a certain phase to the sampled clock it produces for sampling the retransmitted data received at master receiver 170. This phase may be denoted by a variable CDR_CODE. Act 272 also includes reading the value for variable CDR_CODE and setting an initial CDR phase (INT_CDR) equal to CDR_CODE.

As discussed with regard to the slave device data eye margin characterizations, it is arbitrary whether the positive or negative margins for the master device data eye is characterized first. In the method of FIG. 2B, the positive margin is characterized first but it will be appreciated that the negative margin may be first characterized in alternative embodiments. The positive margin is characterized beginning with an act 275 in which the CDR phase CDR_CODE is incremented by one. This unit increment represents the smallest increment possible as determined by the resolution of phase interpolator 171. The pattern error (PAT_ERR) for the received pattern is tested in an act 277 as obtained by sampling the retransmitted data in master receiver 170 responsive to the interpolated clock as incremented according to the incremented CDR phase CDR_CODE. If there are no errors in the received pattern, acts 275 and 277 are repeated until the positive margin is reached. Once an error is detected in act 277, the method continues with an act 280 of characterizing the master device data eye positive margin phase as being equal to the difference between the current incremented value of CDR_CODE and the initial CDR phase INIT_CDR.

With the positive margin phase for the master data eye thus characterized, the method may proceed to characterize the negative margin phase by first enabling the master CDR again in an act 282 to test whether master receiver 170 is again locked to the received data pattern in an act 285. Once lock is achieved, the method continues with an act 287 in which the master CDR is frozen, the CDR phase (CDR_CODE) is read, and an initial CDR phase variable (INIT_CDR) is set equal to CDR_CODE. In an act 290, the CDR phase is decremented by its minimum unit decrement so that the resulting pattern error may be tested in an act 292. If the received pattern has no error, acts 290 and 292 are repeated until an error is detected in act 292. At this point, the negative margin phase (NEG_MARG) may be set equal to the difference between the initial CDR phase (INIT_CDR) and the current value for the decremented CDR phase (CDR_CODE) in an act 295. The master device data eye margin phase minimum (SM_MARGIN) is set equal to the minimum value (MIN) of the positive and negative margin phases in an act 299. In addition, the master device eye center phase (SM_EYE_CENTER) is calculated in act 299 as the difference between the positive and negative margin phases.

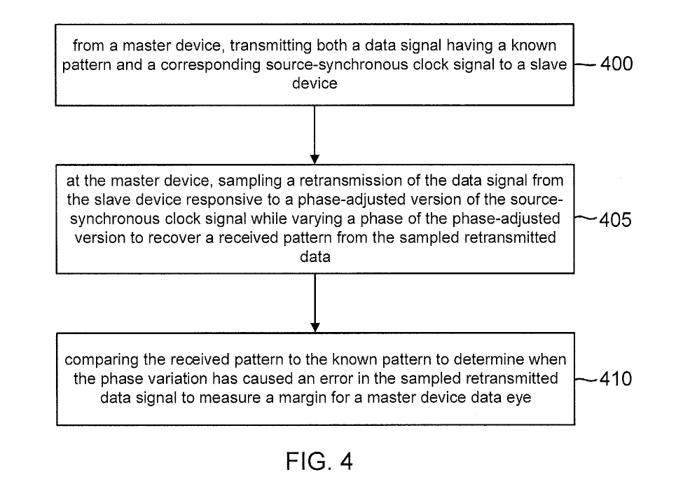

The master device margin phase characterization method is summarized in the flowchart of FIG. 4. The method includes an act 400 performed in a master device. Act 400 includes transmitting both a data signal having a known pattern and a corresponding source-synchronous clock signal to a slave device. The transmission of the data signal over PCB data channel 125 and the source-synchronous clock signal over PCB clock channel 150 in either of systems 100 and 101 is an example of act 400. In addition, the method includes an act 405 that is also performed at the master device and includes sampling a retransmission of the data signal from the slave device responsive to a phase-adjusted version of the source-synchronous clock signal while varying a phase of the phase-adjusted version to recover a received pattern from the sampled retransmitted data. The sampling within master device receiver 170 in either of systems 100 and 101 is an example of act 405. Finally, the method includes an act 410 of comparing the received pattern to the known pattern to determine when the phase variation has caused an error in the sampled retransmitted data signal to measure a margin for a master device data eye. The comparison in pattern checker 175 in either of systems 100 and 101 is an example of act 410.

As those of some skill in this art will by now appreciate and depending on the particular application at hand, many modifications, substitutions and variations can be made in and to the materials, apparatus, configurations and methods of use of the devices of the present disclosure without departing from the scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

We claim:

1. A master device, comprising:
a data transmitter configured to transmit a data signal having a known pattern to a slave device;
a clock transmitter configured to transmit a source-synchronous clock signal to the slave device;
a data receiver configured to sample a retransmission of the data signal from the slave device to recover a received pattern; and
a pattern checker configured to compare the received pattern to the known pattern to characterize a margin for a data eye at the slave device.

2. The master device of claim 1, further comprising:
a multi-phase clock source configured to provide a plurality of source clocks, each source clock in the plurality of source clocks having a unique phase; and
a phase interpolator configured to interpolate between the plurality of source clocks to provide an interpolated clock signal, wherein the data transmitter is configured to successively transmit bits of the data signal responsive to transitions of the interpolated clock signal, and wherein the phase interpolator is further configured to progressively increase a phase of the interpolated clock signal during a characterization by the pattern checker of a positive margin for the data eye at the slave device.

3. The master device of claim 2, wherein the phase interpolator is configured to progressively increase the phase of the interpolated clock signal until the pattern checker detects an error in the received pattern.

4. The master device of claim 2, wherein the phase interpolator is further configured to progressively decrease the phase of the interpolated clock signal during a characterization by the pattern checker of a negative margin for the data eye at the slave device.

5. The master device of claim 4, wherein the phase interpolator is configured to progressively decrease the phase of the interpolated clock signal until the pattern checker detects an error in the received pattern.

6. The master device of claim 2, wherein the multi-phase clock source comprises a four-phase phase-locked loop (PLL).

7. The master device of claim 1, further comprising a memory configured to store the known pattern.

8. The master device of claim 7, wherein the known pattern stored in the memory is a pseudo-random noise pattern.

9. The master device of claim 1, further comprising:
a multi-phase clock source configured to provide a plurality of source clocks, each source clock in the plurality of source clocks having a unique phase, wherein the clock transmitter comprises a phase interpolator configured to interpolate between the plurality of source clocks to provide the source-synchronous clock signal, and wherein the phase interpolator is further configured to progressively increase a phase of the source-synchronous clock signal during a characterization by the pattern checker of a negative margin for the data eye at the slave device.

10. The master device of claim 9, wherein the phase interpolator is configured to progressively increase the phase of the interpolated clock signal until the pattern checker detects an error in the received pattern.

11. The master device of claim 9, wherein the phase interpolator is further configured to progressively decrease the phase of the source-synchronous clock signal during a characterization by the pattern checker of a positive margin for the data eye at the slave device.

12. The master device of claim 1, further comprising:
a multi-phase clock source configured to provide a plurality of source clocks, each source clock in the plurality of source clocks having a unique phase, wherein the data receiver includes a phase interpolator configured to interpolate between the source clocks to produce a sampling clock signal, and wherein the data receiver is configured to sample a retransmitted data signal responsive to the sampling clock signal.

13. The master device of claim 12, wherein the pattern checker is further configured to compare the received pattern to the known pattern while the phase interpolator progressively varies a phase of the sampling clock signal to characterize a margin for a data eye at the master device.

14. The master device of claim 13, wherein the phase interpolator is configured to progressively increase the phase of the sampling clock signal during a characterization of a positive margin for the data eye at the master device and to progressively decrease the phase of the sampling clock signal during a characterization of a negative margin for the data eye at the master device.

15. A method of characterizing a data eye at a slave device, comprising:
at a master device, varying a phase alignment of between a data signal having a known pattern and a corresponding source-synchronous clock signal both transmitted from the master device to the slave device;
while varying the phase alignment between the data signal and the source-synchronous clock signal, sampling a retransmission of the data signal from the slave device at the master device to recover a received pattern from the retransmitted data signal; and
comparing the received pattern to the known pattern to determine when the phase alignment variation has caused an error in the received retransmitted data to measure a margin for the data eye at the slave device.

16. The method of claim 15, further comprising commanding the slave device to cease a clock data recovery operation prior to varying the phase alignment.

17. The method of claim 15, wherein varying the phase alignment between the data signal and the source-synchronous clock signal comprises:
interpolating between a plurality of source clocks to produce a sampling clock signal having a varying phase with regard to the source-synchronous clock signal, wherein transmitting the data signal is responsive to transitions of the sampling clock signal.

18. The method of claim 17, wherein varying the phase of the sampling clock signal comprises progressively increasing the phase of the sampling clock signal until the error is caused in the retransmitted data signal.

19. The method of claim 17, wherein varying the phase of the sampling clock signal comprises progressively decreasing the phase of the sampling clock signal until the error is caused in the retransmitted data signal.

20. The method of claim 15, wherein varying the phase alignment between the data signal and the source-synchronous clock signal comprises:
interpolating between a plurality of source clocks to produce the source-synchronous clock signal so that the source-synchronous clock signal has a varying phase with regard to the data signal.

21. The method of claim 20, wherein interpolating between the plurality of source clocks causes the source-synchronous clock signal to have a progressively increasing phase until the error is caused in the retransmitted signal.

22. The method of claim 20, wherein interpolating between the plurality of source clocks causes the source-synchronous clock signal to have a progressively decreasing phase until the error is caused in the retransmitted signal.

23. A method of measuring a data eye at a master device, comprising:
from a master device, transmitting both a data signal having a known pattern and a corresponding source-synchronous clock signal to a slave device;
at the master device, sampling a retransmission of the data signal from the slave device responsive to a phase-adjusted version of the source-synchronous clock signal while varying a phase of the phase-adjusted version to recover a received pattern from the sampled retransmitted data signal; and
comparing the received pattern to the known pattern to determine when the phase variation for the phase-adjusted version has caused an error in the sampled retransmitted data signal to measure a margin for the data eye at the master device.

24. The method of claim 23, further comprising ceasing a clock data recovery operation in the master device prior to varying the phase of the phase-adjusted version.

25. The method of claim 23, further comprising interpolating between a plurality of source clocks to produce the phase-adjusted version.

26. The method of claim 23, wherein varying the phase of the phase-adjusted version comprises progressively increasing the phase of the phase-adjusted version until the error is caused in the sampled retransmitted data signal.

27. The method of claim 23, wherein varying the phase of the phase-adjusted version comprises progressively decreasing the phase of the phase-adjusted version until the error is caused in the sampled retransmitted data signal.

28. A master device, comprising:
a data transmitter configured to transmit a data signal having a known pattern to a slave device;
a clock transmitter configured to transmit a source-synchronous clock signal to the slave device;
a data receiver configured to sample a retransmission of the data signal from the slave device to recover a received pattern;
means for varying a phase alignment between the transmitted data signal and the transmitted source-synchronous clock signal; and
a pattern checker configured to compare the received pattern to the known pattern while the means varies the phase alignment to characterize a margin for a data eye at the slave device.

29. The master device of claim 28, wherein the means is configured to vary the phase alignment by progressively increasing a phase of the transmitted data signal relative to the transmitted source-synchronous clock signal until the pattern checker detects an error in the received pattern to characterize a positive margin for the data eye at the slave device.

30. The master device of claim 28, wherein the means is configured to vary the phase alignment by progressively decreasing a phase of the transmitted data signal relative to the transmitted source-synchronous clock signal until the pattern checker detects an error in the received pattern to characterize a negative margin for the data eye at the slave device.
